(19) United States
(12) Patent Application Publication
(10) Pub. No.: US 2010/0082465 A1
(43) Pub. Date: Apr. 1, 2010

(54) METHOD AND SYSTEM FOR AUTOMATICALLY CAPTURING BILLABLE TIME

(75) Inventors: Cecily A. Drucker, San Francisco, CA (US); Nova T. Spivack, San Francisco, CA (US); Sunil Maulik, Santa Clara, CA (US)

Correspondence Address: PERKINS COIE LLP, P.O. BOX 1208, SEATTLE, WA, 98111-1208, US

(73) Assignee: Bottom Line Time Inc., San Francisco, CA (US)

(21) Appl. No.: 12/613,361

(22) Filed: Nov. 5, 2009

Related U.S. Application Data
(63) Continuation of application No. 12/178,570, filed on Jul. 23, 2008.
Application No. 12/178,570 is a continuation of application No. 11/178,573, filed on Jul. 11, 2005, now abandoned.

(51) Int. Cl. G06Q 10/00

(52) U.S. Cl. 705/32

(57) ABSTRACT

A method and system helps users capture billable time spent in writing an email and related tasks. A software program is provided that is integrated with an existing email program. The program tracks user time spent on each email and associates billing information with the spent time for use in a billing program.

### CROSS REFERENCE TO RELATED APPLICATIONS

This is a continuation of U.S. patent application Ser. No. 12/178,570, filed on Jul. 23, 2008 by Cecily A. Drucker, Nova T. Spivack and Sunil Maulik entitled: METHOD AND SYSTEM FOR AUTOMATICALLY CAPTURING BILLABLE TIME, which is a continuation of U.S. patent application Ser. No. 12/178,573, filed on Jul. 23, 2008 by Cecily A. Drucker, Nova T. Spivack and Sunil Maulik, which claims the benefit of U.S. Provisional Patent Application No. 61/035,720 entitled “Method and System for Capturing Billable Time”, filed Mar. 11, 2008, and which is incorporated by reference herein.

### BACKGROUND

Professionals in fields such as law, accounting, and consulting frequently bill clients for time spent on a project. The billed time is multiplied by the professional's hourly rate to arrive at a billed amount payable by the client. Unfortunately, current methods of billing time are inaccurate and cumbersome, especially as applied to use of productivity applications such as email activities (reading, reviewing and responding to emails), calendar event time-keeping, task management, VoIP, web-conferencing, and opening, closing and/or manipulating any application or document (whether or not attached to an email), or otherwise electronically available to the user, etc.

For example, many professionals frequently lose track of the amount of time spent composing and responding to emails (which may include research or other background fact gathering). Such oversight can translate into hundreds of billable hours (and thousands of dollars of fees) being lost each year. In addition, users lose the opportunity to value bill and lack a paper trail (other than the emails, themselves, which are archived ‘en masse’) of the emails.

Other tasks which can be billed inaccurately include calendar appointments, completing tasks, and phone calls. Existing time-tracking and billing systems do not focus specifically on tracking and billing for time-spent on such tasks in a manner that integrates directly with existing productivity applications. Instead, existing time-tracking and billing systems provide generic time-tracking and billing mechanisms that do not directly measure or sense actual time spent on email messages—instead they just provide generic time-clocks and rely on users to manually set a billing identifier, provide a description, and manually “punch in” and “punch out.”

Thus, there is a need to automate billing of time by a professional engaging in email and other electronically-generated or controlled activities on behalf of a client.

### BRIEF DESCRIPTION OF THE DRAWINGS

FIG. 1A illustrates an example workstation for providing a billing module.

FIG. 1B illustrates an example mobile device for providing a billing module.

FIG. 2A illustrates a first example screen shot of the billing module on a workstation.

FIG. 2B illustrates a second example screen shot of the billing module on a workstation.

FIG. 3A illustrates an example procedure for a billing module aggregating billable time associated with a plurality of short billable events.

FIG. 3B illustrates an example procedure for a billing module automatically triggering a billing window responsive to a billable event.

FIG. 3C illustrates an example procedure for a billing module automatically generating a description of a time entry related to one or more emails.

FIG. 3D illustrates an example procedure for a billing module automatically billing a billable event occurring on a mobile device.

FIG. 3E illustrates an example procedure for a billing module automatically billing web browsing time.

FIG. 3F illustrates an example procedure for a billing module executing as a daemon.

FIG. 4A illustrates an example procedure for a billing module to automatically capture billable time spent on viewing and composing emails.

FIG. 4B illustrates an example procedure for a billing module to automatically capture billable time spent on viewing and editing email attachments.

### DETAILED DESCRIPTION

A billing module is added to a productivity application to help automatically capture and bill time associated with the application. For example, a billing module plug-in for Microsoft Outlook automatically tracks a user's billable time.

The billing module aggregates billable time amounts for all, or only short, related billable events. The user conducts a plurality of billable events on a workstation, such as reading or composing emails on behalf of the client. Such times are transparently tracked by the billing module to produce a single billing entry including an aggregated billable time amount and a description. This prevents multiple billing entries from being submitted, each related to a separate billing event.

The billing module automatically tracks calendar appointments, task events, reading and composing emails, and other events tracked by the workstation, such as Voice Over IP (VoIP) phone calls. When such events occur, a prompt is displayed to the user to determine whether the event is a billable event and what the billing information is. This improves billable time capture by capturing billable time information at the completion of a calendar appointment, when a task event is marked completed, at the completion of a VoIP phone call, and when an email is read or composed. This eliminates the need for a user to guess at an amount of time spent on such tasks.

The billing module automatically generates a description of the billable event for a billing entry. For example, if the billable event is an email, the billing module can parse the email for keywords or an abstract to generate a description. For example, if the billable event is a calendar appointment, the billing module can parse the appointment's metadata to generate a description. For example, if the billable event is a task event, the billing module can parse the task event's metadata, such as a subject field, to generate a description.

The billing module can be implemented as a software daemon executing in the background of an operating system. This allows the billing module to monitor activities on the workstation, including user inputs and application responses. This eliminates the drawbacks of executing as a plug-in, for example, by only being active when the plug-in application is executing.

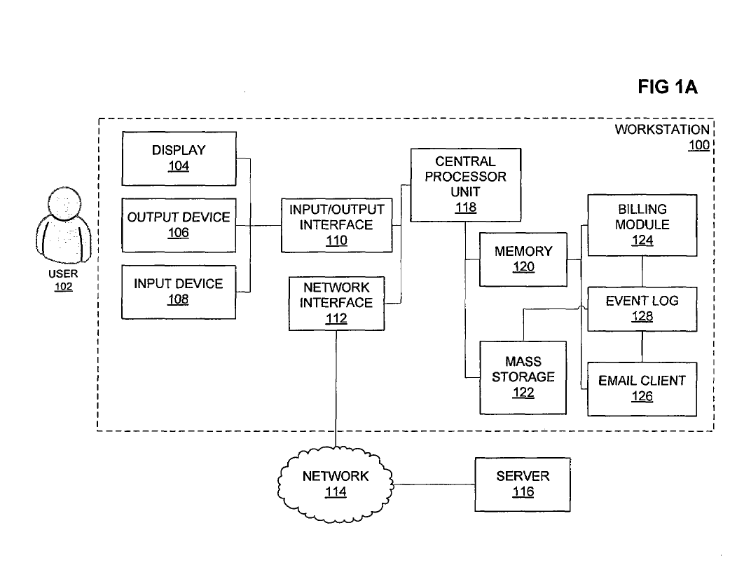

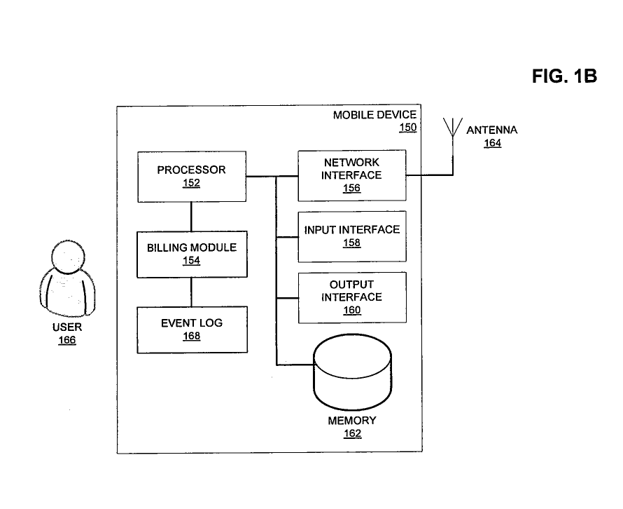

FIG. 1A illustrates an example workstation 100 for providing a billing module. The workstation 100 can execute various productivity applications and provide a user interface to the productivity applications a user 102. For example, the user 102 can be a professional who bills for his time spent on projects on behalf of clients, as discussed above.

The workstation 100 can be a computing device such as a server, a personal computer, desktop, laptop, a personal digital assistant (PDA) or other computing device. The workstation 100 is accessible to the user 102 and provides a computing platform for various productivity applications. Productivity applications can be, for example, as discussed above.

The workstation 100 may include a display 104. The display 104 can be equipment that displays viewable images generated by the workstation 100. For example, the display 104 can be a cathode ray tube or a flat panel display such as a TFT LCD. The display 104 includes a display surface, circuitry to generate a picture from electronic signals sent by the workstation 100, and an enclosure or case. The display 104 can interface with an input/output interface 110, which converts data to a format compatible with the display 104.

The workstation 100 may include one or more output devices 106. The output device 106 can be any hardware used to communicate outputs to the user. For example, the output device 106 can include speakers and printers, in addition to the display 104 discussed above.

The workstation 100 may include one or more input devices 108. The input device 108 can be any computer hardware used to translate inputs received from the user 102 into data usable by the workstation 100. The input device 108 can include keyboards, mouse pointer devices, microphones, scanners, video and digital cameras, etc.

The workstation 100 includes an input/output interface 110. The input/output interface 110 can include logic and physical ports used to connect and control peripheral devices, such as output devices 106 and input devices 108. For example, the input/output interface 110 can allow input and output devices 106 and 108 to be connected to the workstation 100.

The workstation 100 includes a network interface 112. The network interface 112 includes logic and physical ports used to connect to one or more networks. For example, the network interface 112 can accept a physical network connection and interface between the network and the workstation by translating communications between the two. Example networks can include Ethernet, or other physical network infrastructure. Alternatively, the network interface 112 can be configured to interface with wireless network. Alternatively, the workstation 100 can include multiple network interfaces for interfacing with multiple networks.

The workstation 100 communicates with a network 114 via the network interface 112. The network 114 can be any network configured to carry digital information. For example, the network 114 can be an Ethernet network, the Internet, a wireless network, a cellular data network, or any Local Area Network or Wide Area Network.

Alternatively, the workstation 100 can be a client device in communications with a server over the network 114. Thus, the workstation 100 can be configured for lower performance (and thus have a lower hardware cost) and the server provides necessary processing power.

The workstation 100 communicates with a server 116 via the network interface 112 and the network 114. The server 116 can be computing device providing services over the network 114. For example, the server 116 can execute billing software for receiving time entries from the user 102. For example, the server 116 can host a document management system accessible to the workstation 100.

The workstation 100 includes a central processing unit (CPU) 118. The CPU 118 can be an integrated circuit configured for mass-production and suited for a variety of computing applications. The CPU 118 can sit on a motherboard within the workstation 100 and control other workstation components. The CPU 118 can communicate with the other workstation components via a bus, a physical interchange, or other communication channel.

The workstation 100 includes memory 120. The memory 120 can include volatile and non-volatile memory accessible to the CPU 118. The memory can be random access and provide fast access for graphics-related or other calculations. In an alternative, the CPU 118 can include on-board cache memory for faster performance.

The workstation 100 includes mass storage 122. The mass storage 122 can be volatile or non-volatile storage configured to store large amounts of data. The mass storage 122 can be accessible to the CPU 118 via a bus, a physical interchange, or other communication channel. For example, the mass storage 122 can be a hard drive, a RAID array, flash memory, CD-ROMs, DVDs, HD-DVD or Blu-Ray mediums.

The workstation 100 can include a billing module 124. For example, the billing module 124 can be a plug-in for an email client 126. For example, the billing module 124 can be a Microsoft Outlook plug-in or a module for another productivity application.

Alternatively, the billing module 124 and the event log 128 can be configured to interface with any productivity application useful to the user 102.

In one example embodiment, the billing module 124 can be downloadable application utility that helps users track and bill for the time they spend reading and writing emails and related attachments for clients. By providing an effective means to track and bill for time spent in email and related activities such as reading attachments, the billing module 124 improves realization of currently unbilled time. The billing module 124 automates tracking of billable activity (including email activity).

At the user 102's option, the billing module 124 creates an individual billing entry (also known as a time slip) for a billable event. A billable event can be a sent email or a received email read by the user 102. The billing module 124 associates a billing identifier (such as a client/matter number) with a first addressee or domain name of the first addressee of an email. The billing identifier can be a “no bill”, for example, for emails not related to client work. For an email associated with the “no bill” option, the billing module 124 can skip creating a billing entry. The billing module 124 can also have options for the user 102 to select “no bill” for persons who are not associated with client work (e.g., personal acquaintances who are not involved in client work). The billing module 124 can have the option to allow the user 102 to instruct the billing module 124 to “do not ask again” for persons who are not associated with client work, and the billing module 124 will skip a billing entry in the future for such email addresses (until changed by the user 102).

If a billing identifier is not yet available, for example, with a new client or new matter, or if the user 102 wishes to insert correct billing identifier at a later time, a temporary billing identifier can be generated and used. When the billing identifier becomes available, or when the user 102 otherwise elects to insert the billing identifier, the billing module 124 or the user 102 can replace all temporary billing identifiers with the new billing identifier.

The billing module 124 can automatically insert an appropriate billing identifier into the billing entry, or prompt the user 102 for a correct billing identifier. Alternatively, the billing module 124 can retrieve billing identifier information from a billing server. This reduces the necessity of the user 102 selecting the correct billing identifier.

In one example, the billing identifier can be inserted into the email as metadata. Alternatively, the billing identifier can be saved by the billing module 124 on an accessible storage and associated with the email via an email identifier.

The billing module 124 can include a “task” code with the billing entry. “Task” codes can be created by the user 102 or pre-populated from the billing server and describe the task done by the user 102 on behalf of the client. For example, “task” codes can be uniform throughout a professional organization. The task code can be inserted into the email as meta-data, or saved by the billing module 124 on an accessible storage and associated with the email via an email identifier.

The billing module 124 can include a billable time amount with the billing entry. The billable time amount reflects an amount of time spent on the billable event. The billable time amount can be rounded to a user-specified increment, for example, 6 minutes (for 1/10 of an hour), 10 minutes (for ⅙ of an hour), 15 minutes (for ¼ of an hour), or any other increment of time. Alternatively, the billing module 124 can prompt the user to enter a billable time amount or replace the billable time amount with “value billing.” “Value billing” may not correspond to an amount of time spent, but rather a value associated with the task.

The user 102 inputs the appropriate information in a provided graphical user interface (GUI) and submits the information to the billing module 124. For example, the information can be stored in memory 120 until the end of the week or some predetermined time, when the information is uploaded to a billing server. For example, the billing module 124 prompts the user 102 via a pop-up notification to upload the information. Alternatively, the billing module 124 can automatically upload the information.

In another example embodiment, the billing module 124 is a downloadable desktop plug-in for Microsoft Outlook (alternative email platforms, such as Lotus Notes, can also be supported.) Alternatively, the billing module 124 can be an utility that plugs-into or interfaces with email servers (in order to provide functionality across a groups of email accounts on those servers rather than directly within individual email clients), in which case the program's user-interface could be provided to end-users via a plug-in to the email clients, or a separate desktop utility application, or via an HTML-based user-interface from a website.

The billing module 124 automatically tracks and logs user time spent reading, forwarding, replying to, and authoring email messages in the email platform to the event log 128. Event log 128 data can include any or all of: sender, recipient, sent date, received date, message ID, actual time, billed time, user identity, user billing rate, special service billing rate, discounted billing rate, message subject, client name, client code number, case/matter/project/task name, case/matter/project/task code number, file attachment, keyword, subject category, as well as other timed activities (reading, revising attachments, web-browsing, creating new documents, and or additional optional and/or custom tags, or other information). The information to be stored can be programmer-specified or user-specified.

The billing module 124 allows the user 102 to input client and matter names and ID codes at any time: “up-front,” or “just in time” at time of reading, saving, deleting, forwarding, replying, or authoring particular email messages (the “time of interacting with” the message), the time of engaging in, or completing, other timed activities, or at any other point in time.

The billing module 124 automatically associates an email message or other timed activities with relevant clients and matters numbers according to user-customizable rules, or can allow the user 102 to manually associate them via dialog box and/or drop-down menu. The user 102 can also associate a particular billable service and/or billing rate with each particular interaction. A menu of billable services and rates can be provided to the user 102. This enables the user 102 to automatically or manually assign a billing service code and billing rate to each billable event on a per-event, per-matter, or per-client level. The user 102 can also edit or change past billing data, without overwriting their previous Event Log data. The billing module 124 can append the new data into the Event Log and notes it as a later version of an earlier record in the Log—this preserves audit trails and allows for rollbacks.

The billing module 124 can intelligently sense when the user 102 is idle and pause a billing clock until activity resumes. Similarly, the billing module 124 can pause the time billing clock when a message window or the email client is minimized or is in the background and partially or fully obscured by another window or application.

The billing module 124 can add a program icon to Outlook, the operating system toolbar (such as Windows Vista, or Windows 2000), and to other applications that enables the user 102 to manually stop and start the clock at any time, and to reassign what client and/or matter is being billed for at any given time.

The billing module 124 can automatically compile real-time reports on time spent, statistics, and billable time for users. The billing module 124 can provide hourly, daily, weekly, monthly, quarterly and annual summary reports of activity and billings to the end-user. These reports can be exported in a variety of common formats so that e-mail billing data can be generated from them, and/or integrated with other billing data, in external applications. The billing module 124 can also optionally enable the user to directly generate and print invoices directly from within the billing module 124. The billing module 124 can also export the event log 128, as well billing data in common data formats for use in other applications.

The billing module 124 can import or export client and matter codes to/from tab or comma delimited files, or Excel format spreadsheets, or other file formats. In addition, the billing module 124 can provide a simple wizard driven module that enables this data to be data-entered quickly by the end-user or their assistant. Users can simply paste this data into the billing module 124 after copying it from another file that contains it in the correct format.

The billing module 124 and event log 128 import/export can also take place via HTTP, HTTPS, SOAP, or XML-RPC, or other client-server or communication protocols, in order to integrate local copies of the billing module 124 or event log 128 with server-based applications such as centralized billing systems in enterprises. Another version of the billing module 124 and event log 128 might be designed to directly integrate with popular time-and-billing applications, such as other leading enterprise server applications.

The billing module 124 can require a registration code before the application is fully “unlocked”—for example, it can be useable on a trial-basis for free, but some features can not be available and no reports or other data can be imported/exported without a payment and a subsequent license key. The billing module 124 can be fully or partially functional for a predetermined period of time before requiring registration.

The billing module 124 can be manually or automatically updated. Automatic updates can be available only to paying customers and require an active Internet connection.

The billing module 124 can enable client and matter ID codes to be attached to email messages that are sent from Outlook, and to be automatically harvested from incoming Outlook email messages from others. This functionality enables users to easily share client and matter numbers with their collaborators, so that those other parties can associate their work on the items and related items with the same numbers.

The billing module 124 can optionally include an advanced capability to intelligently learn or infer the appropriate client/matter/case/project/task to associate a given email message with over time. This learning and/or inference can take place via a statistical analysis of existing associations entered by the end-user or others. For example, whenever a user associates a particular message with a particular client/matter/case/project/task, the billing module 124 can then associate the addresses, date, subject, body text and any attachments, with that client/matter/case/project/task. As enough of these associations are accumulated it becomes possible for the billing module 124 to suggest, or even to automatically determine, which client/matter/case/project/task to bill time-spent on a given email message to.

Users can potentially speed up the learning process or even circumvent it by defining some simple rules in the billing module 124. An example rule can be “Any messages from myself to joe@company.com that contain the keywords ‘trademark’ or ‘software’ are to be billed to client 1, matter 4, except if they contain keyword ‘airplanes’ in which case bill them to client 1, matter 6.”

The billing module 124 can discover mistakes, based on its learning from past examples, such as times when a user accidentally bills an email to the wrong matter, and can notify the user and/or suggest corrections.

The billing module 124 can also have billing rules, such as “for email messages to or from joe@company.com bill for my time at a rate of $200/hour, to a maximum of $1000.00 per month” or “for email messages to or from sue@organization.com bill a flat fee of $20 for each email I read or send,” or even “for email messages to or from john@customer.com track and report my time but do not bill anything at all.” Note that all of the above billing rules are paraphrased for simplicity within this document and can or can not actually be composed or displayed in natural language within the billing module 124.

In an alternative embodiment, sent and received emails can be parsed outside of the workstation 100, for example, at the email server, at another server, or in a “cloud” computing model. This allows the billing module 124 to utilize computing resources not available at the workstation 100. This also allows a subscription revenue model by charging a periodic payment for processing the billable time amounts associated with each billing identifier for the user 102.

In an alternative embodiment, the time slip or billing information can be uploaded to the billing server as it is created by the billing module 124. This eliminates the periodic uploading of batch time slips and allows real-time billable information analysis at the billing server.

It will be appreciated that the billing module 124 can track billable events and export billable event information to an external or third party application. As discussed above, the external application can be a billing software.

In an alternative embodiment, the billable event information can be exported to a customer relations management (CRM) application to log emails, phone calls, and other contacts with clients.

In an alternative embodiment, the billable event information can be exported to a project management application to log and track time spent on a project.

It will be appreciated that the billable event information can be exported to any external or third party application.

In one example embodiment, the user is prompted for billing information after a billable event has been detected. The prompt can be displayed when the billable event is detected, or after the billable event is completed. A form can be displayed with billing information pre-populated with billing information, as discussed above. The billing record can be associated with a globally unique identifier, for example, a time stamp or a hash result of the billable event. This associates the billing record with the billable event at the work station.

The prompt can ask the user whether a billing record should be completed for the billable event. If the user does not desire to bill the time, for example, the billable event was in fact not billable, the user responds “no.” If the user desires to bill the time, the user responds “yes” and completes the displayed form, as discussed above. If the user desires to never be asked again about the particular billable event (for example, an email to a specified email addressee), the user responds “do not ask again.”

In one example embodiment, a report sorted by billing identifiers is displayed to the user prior to submission or upload to a billing server. The user can view the report, edit billing information for any billing record, round billable time up or down. Other functionality can also be supported. The user can then submit or delete the billing records.

A billing record can be created whenever a billable event starts. A timer can automatically be started whenever a billable event is detected. An elapsed time can be used to pre-populate the billing record when the billable event ends. This allows email reading time to be captured.

In one example embodiment, the email application can create folders organized by billing identifiers. The email application automatically places incoming and outgoing emails in an appropriate folder.

In one example embodiment, a billing record can be edited by the user to include time spent on off-line activities. This is helpful for users who do not already have a billing system in place.

In one example embodiment, the billing module 124 “auto-archives” emails. Emails are automatically saved in folders that correspond to a billing identifier. Further, the billing module 124 automatically deletes duplicate emails. The billing module 124 automatically deletes any quoted reply portion of a received email to eliminate duplicates. The billing module 124 also automatically attaches the billing identifier to subsequent reply emails.

FIG. 1B illustrates an example mobile device for providing a billing module. The mobile device 150 can be a mobile computing device, cellular phone, a PDA, a laptop computer, or any portable computing device configured to communicate via a wireless network. The mobile device 150 responds to user commands and displays output.

The mobile device 150 includes a processor 152. The processor 152 can be a general-purpose processor configured to execute computer-readable instructions operating the mobile device 150 and associated peripherals. In an example embodiment, the mobile device 150 can include multiple specialized processors, each processor optimized to perform a specific type of processing, such as encryption and decryption, graphics-related calculations, or other specialized processing.

The mobile device 150 includes a billing module 154. The billing module 154 is configured to provide billing functionality, as discussed above and below. In one example embodiment, the billing module 154 forwards all mail sent from the mobile device 150 to a desktop computer. The desktop computer is also executing a billing module, which flags the incoming email for billing. The desktop computer can prompt the user 166 for billing information associated with the email.

The mobile device 150 includes an event log 168. The event log 168 can be emailed to the server for the user 166 to further process, as discuss above. In one embodiment, the event log 168 can store output from the mobile device 150. Alternative embodiments may be as described above.

In an alternative embodiment, the billing module 154 is similar to the billing module illustrated in FIG. 1A. Thus, the billing module 154 includes functionality to detect a billable event, determine a billing identifier, calculate a billable time amount, and determine a billable event description. Billing information can be uploaded to a desktop computer or a billing server.

The mobile device 150 includes a network interface 156. For example, the network interface 156 communicates with a cellular wireless network or a short range wireless network. The network interface 156 converts outgoing voice and data signals to wireless signals for transmission. The network interface 156 also converts incoming wireless signals to voice and data signals. The mobile device 150 can include multiple network interfaces or a network interface configured to interface with multiple networks. Wireless network interfaces can communicate via an antenna 164.

The mobile device 150 includes an input interface 158. The input interface 158 can receive user inputs from an input device and convert the user inputs into user commands. For example, input devices can include a touch screen display, a keypad, a microphone, a pointer device, a scroll wheel, a camera, or other input devices.

The mobile device 150 includes an output interface 160. The output interface 160 transmits output to an output device in a form accessible to the user 166. For example, output devices can include a display screen, a speaker, an audio-out jack, an electro-mechanical motor for providing tactile output, or other output devices.

The mobile device 150 includes a memory 162. The memory 162 can be read-only or read-write, persistent or volatile memory accessible to the processor 152. The memory 162 can store data required by the mobile device 150 for execution.

The mobile device 150 can be used by a user 166. The user can operate the mobile device 100 to retrieve and view content, and also to view server-selected relevant content selected, in part, based on the mobile device 100's physical location and local time.

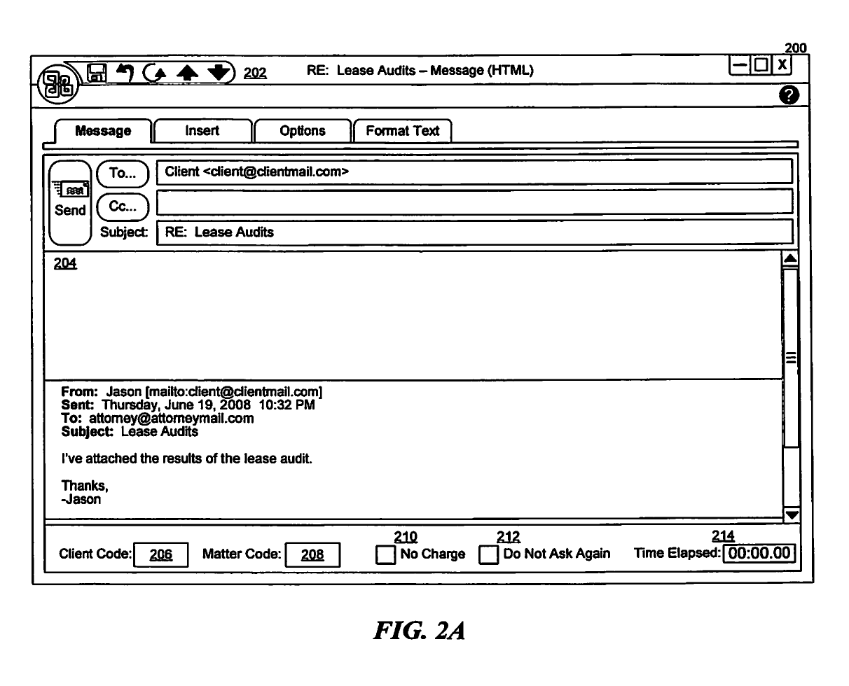

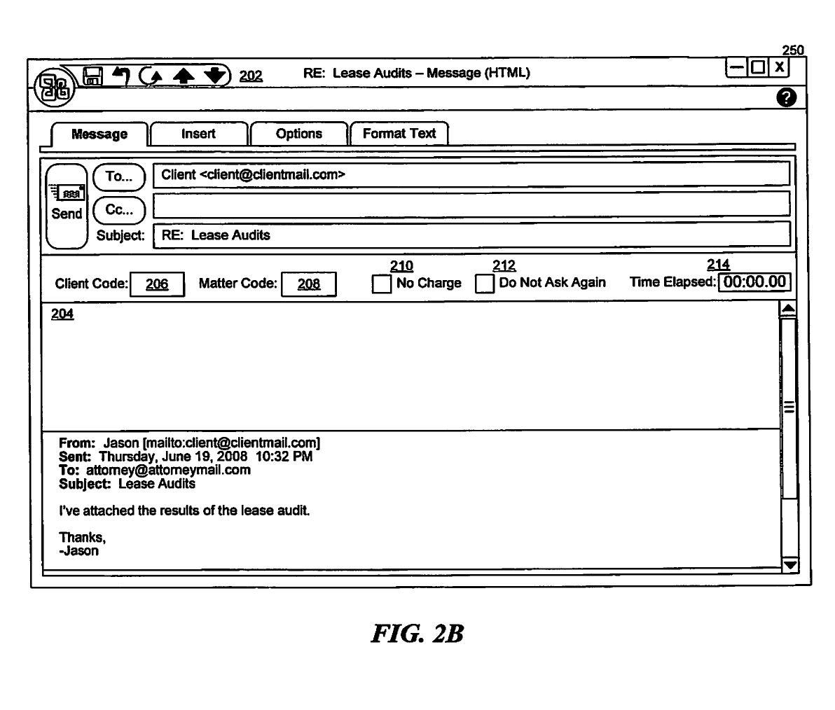

FIG. 2A illustrates a first example screen shot 200 of a billing module on a workstation. The billing module can be integrated into an email client 202 as a plug-in to capture billable time spent on drafting emails, as discussed above. The email client 202 provides email functionality to a user. Alternative embodiments of the billing module can be used, as discussed elsewhere, where the billing module captures time spent on billable events detected by the workstation.

As an email client plug-in, the billing module can provide billable time capture functionality whenever the user composes an email, for example, a new email or a reply email. The billing module can detect a first addressee from the “to” field.

The email client 202 includes various menus and tools to provide email and related functionality. Example functionality can include address book, attachment management, contacts management, spell check, etc.

The email client includes an email composition area 204. The email composition area 204 can be a text area where a user inputs in an email body, for example, by typing or utilizing a voice recognition software application. For example, the email composition area 204 can support formatting and other composition features.

The billing module can include a client code input area 206. The client code input area 206 receives a client identifier associated with a specific client within a billing system.

For example, the client code input area 206 can support auto-complete, in which a quantity of possible client codes are displayed responsive to each user-inputted character. In an alternative example, the client code input area 206 can be automatically filled by the billing manager. For example, an address in the “to” field can be associated with a specific client code.

For example, a specific word or phrase, in the “subject” field can be associated with a specific client code. For example, a client code can be embedded in an email body, to which the user is drafting a reply.

The billing module can include a matter code input area 208. The matter code input area 208 receives a matter identifier associated with a specific matter within a billing system. As discussed above, the matter code can be inputted by the user, auto-filled or auto-completed by the billing module.

For example, the client code input area 206 and matter code input area 208 can be text fields, drop-down menus, or any other GUI input widget. Additional input areas can be used, for example, to receive an activity code or other billing information. The billing module can provide a search engine allowing the user to search for a correct billing information.

The billing module can include a “no charge” selection box 210. The “no charge” selection box 210, if selected by the user, indicates the time spent on the email is not to be charged.

The billing module can include a “do not ask again” selection box 212. The “do not ask again” selection box 212, if selected by the user, indicates that emails sent to the email addressee should never be billed in the future. It will be appreciated that the user can negate a designation of an email address as a “do not ask again” via the billing module.

The billing module can include an elapsed time display box 214. The elapsed time display box 214 displays an elapsed time of a timer started when the email draft was created. In one embodiment, the elapsed time display box 214 can be hidden, for example, to prevent distracting the user. In one embodiment, the timer can pause when the email client is minimized, so that only time spent drafting the email is captured.

The billing module inputs discussed above can be hidden responsive to a user input.

FIG. 2B illustrates a second example screen shot 250 of a billing module on a workstation. FIG. 2B is similar to FIG. 2A and includes a billing module integrated into an email client 202 as a plug-in. The email client includes an email composition area 204. The billing module can include a client code input area 206, a matter code input area 208, a “no charge” selection box 210, a “do not ask again” selection box 212, and an elapsed time display box 214.

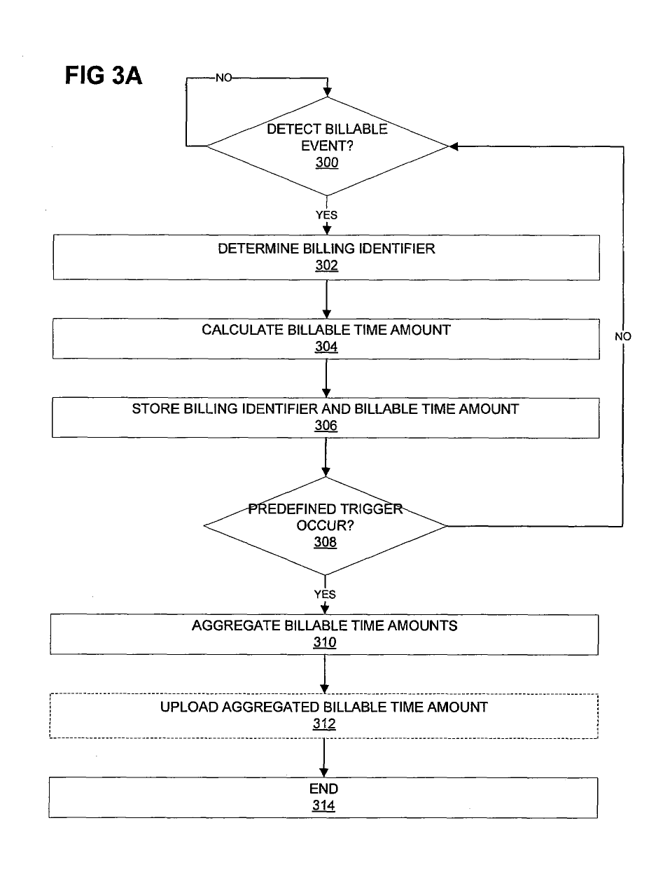

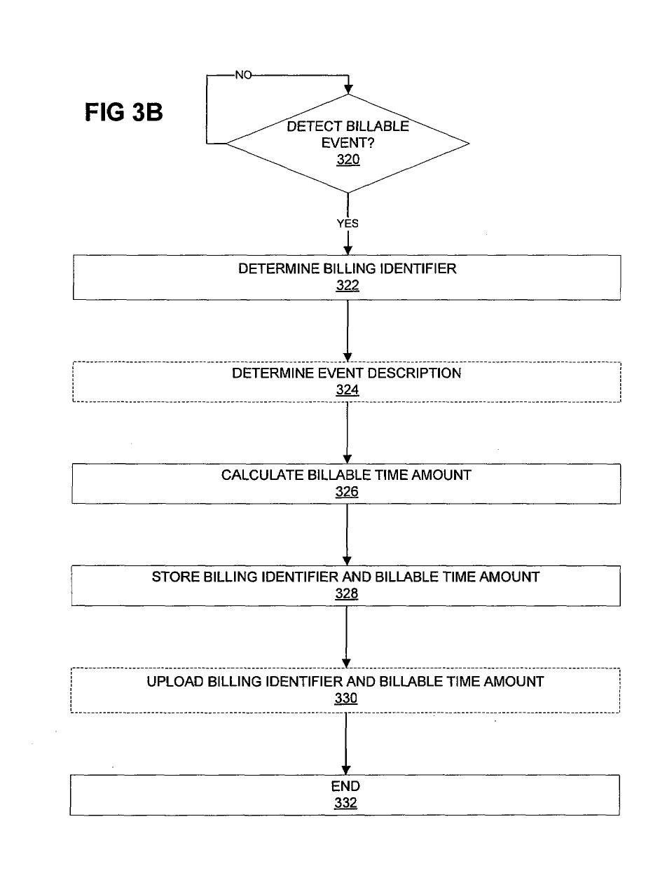

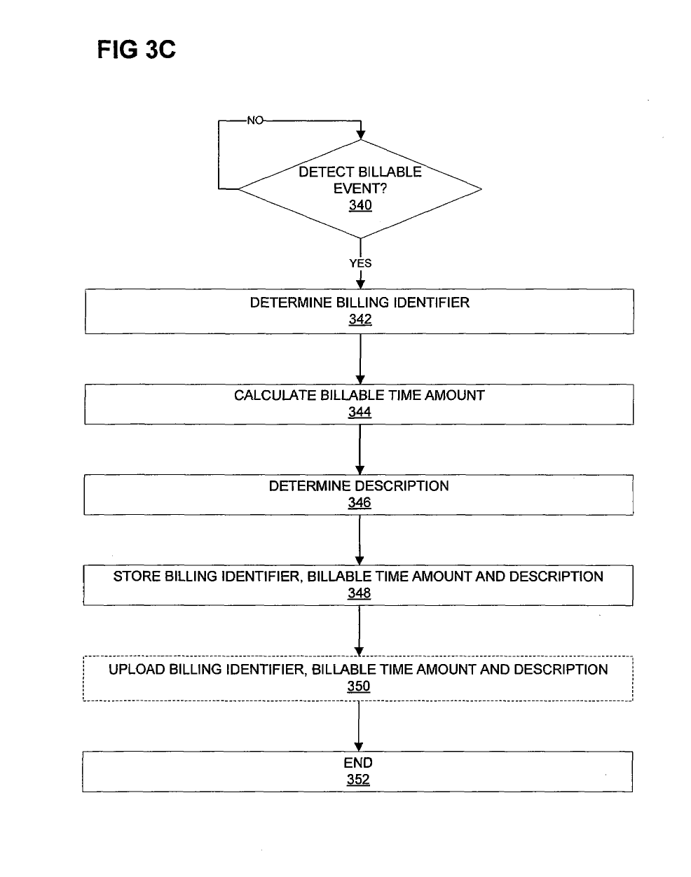

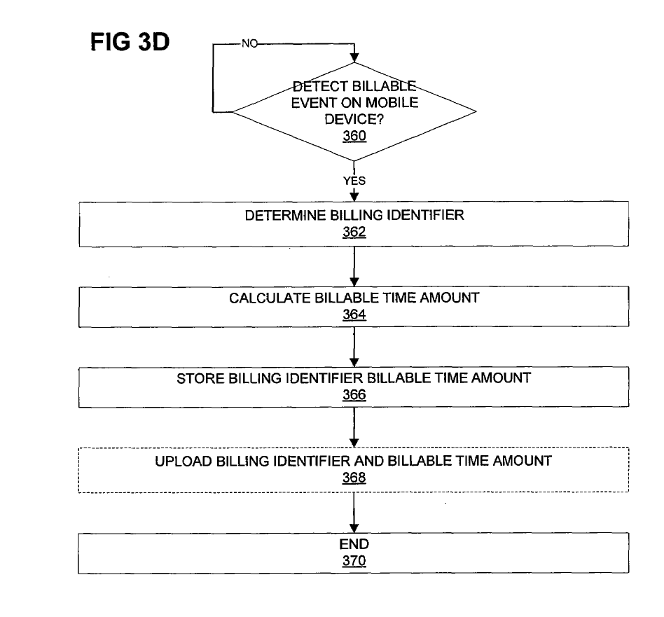

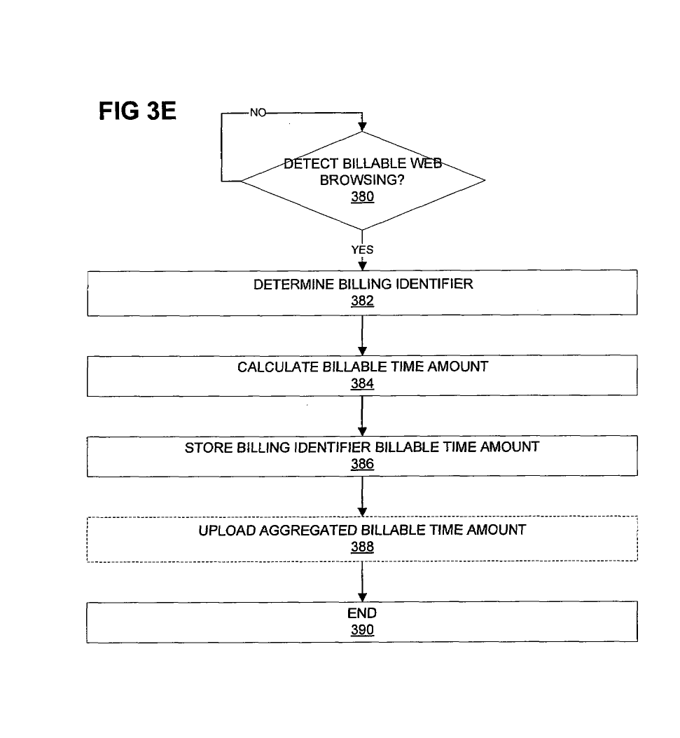

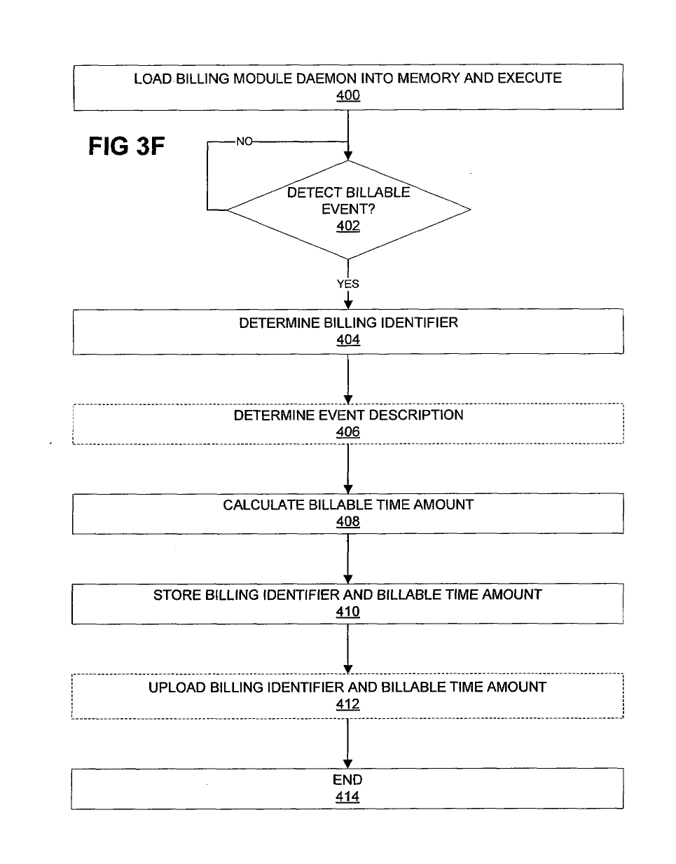

FIG. 3A illustrates an example procedure for a billing module aggregating billable time associated with a plurality of billable events. The billing module can execute on a workstation as illustrated in FIG. 1A or a mobile device as illustrated in FIG. 1B. Alternatively, the billing module can execute on a server in communications with a workstation or a mobile device. For example, a user can desire to not submit a time slip for every short billable event, but rather aggregate related short billable events together into one time slip. A “short” billable event can be defined as a billable event with a billable time amount less than a user-selected threshold. Billable events can be related if they are associated with the same billing identifier.

In 300, the billing module determines whether a billable event has been detected. A billable event can be any event that occurs at a workstation responsive to a user request benefiting a client. Alternatively, a billable event can be any detected event that is initiated by the user on behalf of the client. For example, a billable event can be reading an incoming email, composing an outgoing email, drafting, reviewing or revising any document in a productivity application, conducting electronic research on the Internet, VoiP activities, participating in webinars on the Internet, participating on electronic meetings on the Internet, etc. Electronic meetings can include online conferences that are in an instant messaging format.

As a plug-in, the billing module can receive a notification whenever a billable event occurs on a productivity application. Alternatively, the billing module can monitor workstation functions to determine whether a billable event has occurred. Alternatively, the billing monitor can monitor a display screen of the workstation to determine whether a billable event has occurred. Alternatively, the billing module can monitor keystroke activity, voice recognition activity, VoIP and other audio or visual cues to determine whether a billable event is occurring or has occurred.

If, for example, the billable event is a calendar appointment, the billing module can detect calendar appoints as they occur during the day. In an alternative, the billing module can scan the calendar periodically and compile a list of potential billable events to present to the user for billing.

If a billing event has been detected, the billing module proceeds to 302. If no billable event is detected, the billing module continues to wait at 300.

In 302, the billing module determines a billing identifier. The billing identifier, as discussed above, can be a client/matter number identifying the client and the matter to which the billable time should be billed. In one example, the billable event is reading or drafting an email, and the billing identifier is associated with an addressee of the email, as discussed above. The billing identifier is thus determined from the email addressee. In one example embodiment, the billing identifier is determined from the first email addressee of the email.

In another example, the billable event is drafting a document in a productivity application, and the billing identifier is retrieved from metadata associated with the document. In another example, the billable event is the user conducting electronic research on an Internet browser, and the billing identifier is received from the user responsive to a billing module prompt.

Additionally, a task code or task identifier can be determined. The task code or task identifier can describe a task performed by the user for the client. The task code can be predetermined in a billing server and downloaded to the workstation. The task code or task identifier can be stored with the billing identifier.

In 304, the billing module calculates a billable time amount. The billable time amount is an amount of time to be billed to the client. For example, the billable time amount can be automatically tracked by the billing module through timers that start and stop responsive to the user initiating and terminating the billable event. Alternatively, the billable time amount can be entered by the user responsive to a prompt. Alternatively, the billing module can utilize a value billed instead of the billable time amount, wherein the value billed is equal to a price to be paid by the client, instead of actual time spent on the billable event.

In 306, the billing module stores the billing identifier and billable time amount in an accessible memory. For example, the accessible memory can be volatile or non-volatile memory on the workstation.

If the billable time amount is lower than a user-set threshold, for example, five minutes, the billing identifier and billable time amount can be stored in a temporary variable for later aggregation into one time slip or billing entry. This prevents multiple billing entries for short billable events from appearing on a bill, each representing a short event (such as reading or writing an email).

In 308, the billing module determines whether a predefined trigger has occurred. The predefined trigger can trigger an aggregation of billable time amounts, as discussed below. The trigger can be a periodic deadline such as an end of day, end of week, or end of month. Alternatively, the trigger can be reaching a threshold amount of aggregated billable time amount. Alternatively, the trigger can be any other condition set by the user or programmer.

If the predefined trigger has occurred, the billing module proceeds to 310. If the predefined trigger has not occurred, the billing module proceeds to 300.

In 310, the billing module aggregates stored billable time amounts associated with a selected billing identifier. For example, the billing module can aggregate stored billable time amounts for each billing identifier used by the user since the last aggregation. For each billing identifier, the billing module retrieves billable time amounts stored in temporary variables for aggregation. Thus, each billing identifier is associated with an aggregated billable time amount aggregated from all the billable time amounts lower than the user-set threshold. This amount reflects the aggregated amount of billable time spent by the user related to the billing identifier.

In one embodiment, the billing module aggregates billable time based on a billing identifier, as discussed above. In another embodiment, the billing module aggregate billable time spent on reading and composing emails based on an email addressee.

In 312, the billing module optionally uploads the aggregated billable time amount to a billing server responsive to a trigger. The billing module can also upload the billing identifier. For example, the trigger can be a predetermined deadline (every hour, day, week, etc.) or a user request.

Billing information can be uploaded as plain text, in Extended Markup Language (XML), in a proprietary format used by the billing server, or any other format. The upload can be conducted over a secure connection with the billing server. The billing information can be encrypted or otherwise secured during the upload.

It will be appreciated that billing information for a plurality of billable events can be queued on the workstation for a periodic upload. Alternatively, billable information can be uploaded as soon as completed by the user and the billing module.

It will be appreciated that each billing identifier and billable time amount 306 can be stored in an individual time slip or billing entry. The billing entries are then aggregated in 310 responsive to a predefined trigger into an aggregated billing entry. The aggregated billing entry can be uploaded in 312.

In 314, the billing module exits the procedure.

FIG. 3B illustrates an example procedure for a billing module automatically triggering a billing window responsive to a billable event. The billing module can execute on a workstation, a mobile device, or a server, as discussed above.

In 320, the billing module determines whether a billable event has been detected. The billable event can be detected as discussed above.

Alternatively, the billable event can be an expiration of a calendar appointment. For example, the billing module can interface with a calendar application and be notified when a calendar appointment event ends. The billing module can automatically prompt the user to enter billing information related to the calendar appointment.

Alternatively, the billable event can be completion of a task object. For example, the billing module can interface with a task application that tracks to-do tasks for the user. The billing module is notified when the user checks off a task as completed. The billing module can automatically prompt the user to enter billing information related to the completed task.

Alternatively, the billable event can be completion of a Voice over IP (VoIP) phone call, or any other phone call that can be monitored by the desktop. For example, the billing module can interface with a desktop module that monitors incoming and outgoing phone calls. The billing module can automatically prompt the user to enter billing information related to the phone call.

Alternatively, the billable event can be opening an attachment of an email. For example, the attachment can be productivity application files, such as word processing, spreadsheet, presentation, or similar application. The billing module detects when the attachment is opened by a third party application for viewing or editing.

In one example, the billing module starts a timer when the attachment is opened, and stops the timer when the attachment is closed. In this example, the user can be warned when attempting to close the billing module that the timer will stop. In another example, the timers can run even when the billing module is closed.

If a billing event has been detected, the billing module proceeds to 322. If no billable event is detected, the billing module continues to wait at 320.

In 322, the billing module determines a billing identifier. The billing identifier can be detected as discussed above.

In 324, the billing module optionally determines an event description. The event description can be a text field describing the billable event. For example, the event description can be user-inputted. Alternatively, the event description can be automatically generated, as discussed below.

In 326, the billing module calculates a billable time amount. The billable time amount can be calculated as discussed above.

In 328, the billing module stores the billing identifier and billable time amount in an accessible memory. The billing identifier and billable time amount can be stored as discussed above.

In 330, the billing module optionally uploads the billing identifier and billable time amount to a billing server responsive to a trigger, similar to as discussed above.

In 332, the billing module exits the procedure.

FIG. 3C illustrates an example procedure for a billing module automatically generating a description of a time entry related to one or more emails. The billing module can execute on a workstation, a mobile device, or a server, as discussed above.

In 340, the billing module determines whether a billable event has been detected. The billable event can be detected as discussed above.

If a billing event has been detected, the billing module proceeds to 342. If no billable event is detected, the billing module continues to wait at 340.

In 342, the billing module determines a billing identifier. The billing identifier can be detected as discussed above.

In 344 the billing module calculates a billable time amount. The billable time amount can be calculated as discussed above.

In 346, the billing module determines an event description. The event description can be a text field describing the billable event. For example, the event description can be user-inputted. The billing module prompts the user for a description of the billable event. For example, a prompt can be displayed with input fields for the billing identifier, the billable time amount, and the event description. The billing identifier field and the billable time amount fields can be pre-filled by the billing module if automatically determined above.

Alternatively, the event description can be automatically generated. The billing module can automatically extract metadata and keywords from the billable event. For example, email metadata includes an addressee, a subject line, and a text body. For example, calendar appointment metadata includes subject, a location, and start and end times. For example, task event metadata includes a subject. For example, VoIP phone call metadata can include the name of the recipient of the phone call.

The billing module then generates an event description from the extracted metadata and keywords. For example, the description can be generated from a predetermined formula. An email description can be “Email to [recipient] regarding [subject line].” However, such descriptions can be inaccurate when email recipients fail to update the subject line in reply messages. A better email description can be “Email to [recipient] regarding [relevant keywords from email body]”, where the billing module selects relevant keywords from the email body that best represent the meaning of the email.

Similar procedures can be used to generate event descriptions for calendar appointments and task events.

A VoIP phone conversation can be monitored by the billing module with a speech-recognition engine to extract keywords from the phone conversation. Similar to the email procedure discussed above, the billing module can generate an event description.

In another example, the billing module can provide the metadata and keywords to a third-party module that utilizes syntax and grammar rules to create a summary of the billable event.

The above procedures can be used to automatically generate a concise and descriptive event description for the billing entry.

In 348, the billing module stores the billing identifier, billable time amount and event description in an accessible memory, similar to 328 of FIG. 3B.

In 350, the billing module optionally uploads the billing identifier, billable time amount and description to a billing server responsive to a trigger, similar to 350 of FIG. 3B.

In 352, the billing module exits the procedure.

FIG. 3D illustrates an example procedure for a billing module automatically billing a billable event occurring on a mobile device. The billing module can execute on a workstation, a mobile device, or a server, as discussed above.

In 360, the billing module determines whether a billable event has been detected on a mobile device. For example, a mobile device can be a personal digital assistant (PDA), a cellular phone, etc. The billable event can be detected as discussed above.

In one example embodiment, the billable event can include cellular phone calls made from the mobile device.

In one example embodiment, all emails composed on a mobile device are automatically forwarded to a workstation, which filters the emails into a special folder and processes the emails as billable events. Similarly, all emails which are read on the mobile device are automatically forwarded to the workstation. As discussed above, the workstation includes a billing module that processes emails, including emails forwarded from the mobile device. The emails can be forwarded by carbon copying (cc:) or blind carbon copying (bcc:) the user's email account.

In an alternative embodiment, the emails can be forwarded by carbon copying (cc:) or blind carbon copying (bcc:) a predetermined email account that will handle processing the emails as billable events.

In an alternative embodiment, the user manually carbon copies or blind carbon copies emails to a predetermined address, which will handle processing the emails as billable events.

In one example embodiment, a mobile billing module is installed on the mobile device, wherein the mobile billing module provides similar functionality as the billing module discussed above.

If a billing event has been detected, the billing module proceeds to 362. If no billable event is detected, the billing module continues to wait at 360.

In 362, the billing module determines a billing identifier. The billing identifier can be detected as discussed above. If the billable event includes a phone call, the mobile device can perform a voice recognition procedure to determine a billing identifier from a content of the phone call.

In one example embodiment, the mobile device can automatically determine the billing identifier. For example, an email contacts list can associate contacts with specific billing identifiers. For example, the user 166 may select an “insert later” billing identifier.

In 364 the billing module calculates a billable time amount. The billable time amount can be calculated as discussed above.

It will be appreciated that an event description can also be determined, as discussed above.

In 366, the billing module stores the billing identifier and the billable time amount in an accessible memory, as discussed above.

In 368, the billing module optionally uploads the billing identifier and the billable time amount to a billing server responsive to a trigger, as discussed above.

In 370, the billing module exits the procedure.

In one embodiment, the mobile billing module executes on the mobile device, while a workstation billing module executes on the workstation. The two billing modules communicate via conventional synchronization systems. The workstation billing module stores billing information in a contact management application. For example, billing information is associated with an email address by the workstation billing module. The workstation billing module adds the billing information to a contact within the contact management application associated with the email address. The contact of the contact application is transmitted to the mobile device during a synchronization procedure. Thus, the mobile device can easily determine a billing information of an email message by looking up the contact in the contact application.

FIG. 3E illustrates an example procedure for a billing module automatically billing web browsing time. The billing module can execute on a workstation, a mobile device, or a server, as discussed above.

In 380, the billing module determines whether billable web browsing has been detected. The web browsing can be detected by detecting an active instance of a web browser, such as Internet Explorer or Mozilla Firefox, and automatically starting a timer when the billing module detects browsing activity.

In one example embodiment, the billing module stores a list of personal or non-billable websites. Any web browsing on such websites are not billable events. In one example embodiment, the billing module stores a list of billable websites from which the user selects. In one example embodiment, the billing module determines whether the web browsing is billable based on the user's specifications.

In another example embodiment, the billing module detects a Universal Resource Locator (URL) address within a received email. For example, the received email can be associated with a billing identifier and the URL address can be for a webpage. When the user accesses the webpage, the billing address will create a billing entry for the web browsing based on the billing identifier of the received email.

In another example embodiment, the email can be subsequently closed, but the billing module continues to detect user activity on the opened webpage. When user activity ceases on the opened webpage, the billing entry will be completed.

If billing web browsing has been detected, the billing module proceeds to 382. If no billable web browsing is detected, the billing module continues to wait at 380.

In 382, the billing module determines a billing identifier. The billing identifier can be detected as discussed above. In addition, the billing module can detect a billing identifier associated with a website. For example, the billing module can detect the user is browsing a client's intranet, and associate the browsing time with the client's billing identifier.

In 384 the billing module calculates a billable time amount. The billable time amount can be calculated as discussed above. An event description can also be determined, as discussed above.

In 386, the billing module stores the billing identifier and the billable time amount in an accessible memory, as discussed above.

In 388, the billing module optionally uploads the billing identifier and the billable time amount to a billing server responsive to a trigger, as discussed above.

In 390, the billing module exits the procedure.

It will be appreciated that the above systems and procedures can be used on any productivity or other applications where billable time must be recorded. By automating the recording of billable information, the billing module reduces loss of billable time.

FIG. 3F illustrates an example procedure for a billing module executing as a daemon. The billing module, as discussed above, can execute on a workstation, server or mobile device. In this embodiment, the billing module executes as a software daemon in a background of an operating system instead of a plug-in into a third-party application. The billing module therefore monitors all user activities at the workstation, including billable events. The billing module can also open third-party applications, if necessary, responsive to user inputs.

In 400, the billing module daemon is loaded into memory and executed by the workstation. For example, the daemon can be loaded during a startup of the workstation.

In 402, the billing module determines whether a billable event has been detected. The billable event can be detected as discussed above. As a daemon executing in the background, the billing module can detect any user and workstation activity.

If a billing event has been detected, the billing module proceeds to 404. If no billable event is detected, the billing module continues to wait at 402.

In 404, the billing module determines a billing identifier. The billing identifier can be detected as discussed above.

In 406, the billing module optionally determines an event description. The event description can be a text field describing the billable event. For example, the event description can be user-inputted. Alternatively, the event description can be automatically generated, as discussed above.

In 408, the billing module calculates a billable time amount. The billable time amount can be calculated as discussed above.

In 410, the billing module stores the billing identifier and billable time amount in an accessible memory. The billing identifier and billable time amount can be stored as discussed above.

In 412, the billing module optionally uploads the billing identifier and billable time amount to a billing server responsive to a trigger, similar to as discussed above.

In 414, the billing module exits the procedure.

In one embodiment, the billing module automatically interfaces with applications to transfer billable event information. For example, the billing module can interface with a calendar application to create or update calendar appointments from billing information. In this example, a calendar appointment can be updated with the start and stop time as detected by the billing module. In a “Day” display in Microsoft Outlook, this will allow the user to visualize time that is unaccounted-for during a work day. In an alternative embodiment, this functionality can be provided by a Microsoft Outlook plug-in.

In one embodiment, the billing module provides a billing information input form responsive to a user request. This can be used by the user to input billing information for billable events that are not automatically detected by the billing module, such as making or receiving phone calls, participating in conferences, reviewing paper files, etc.

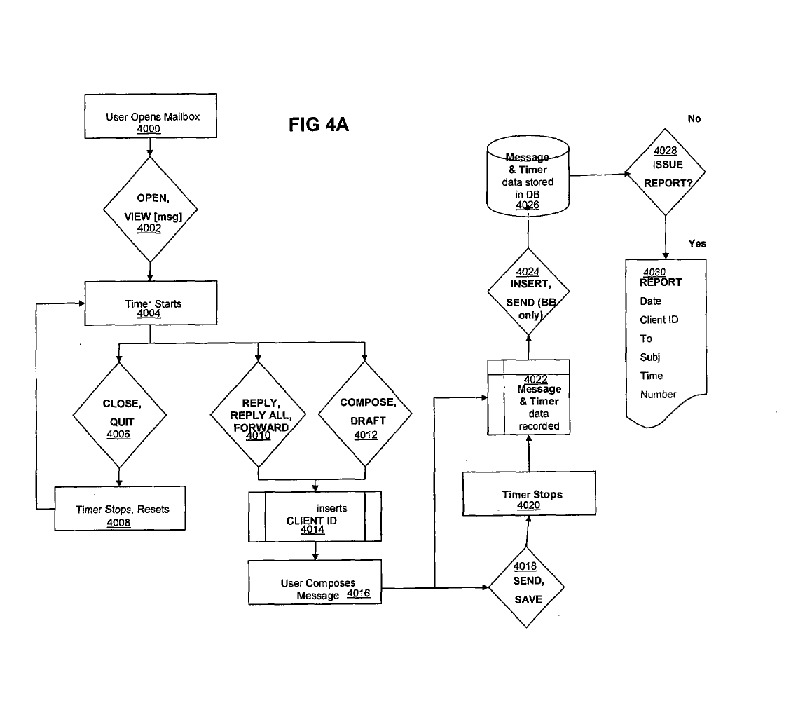

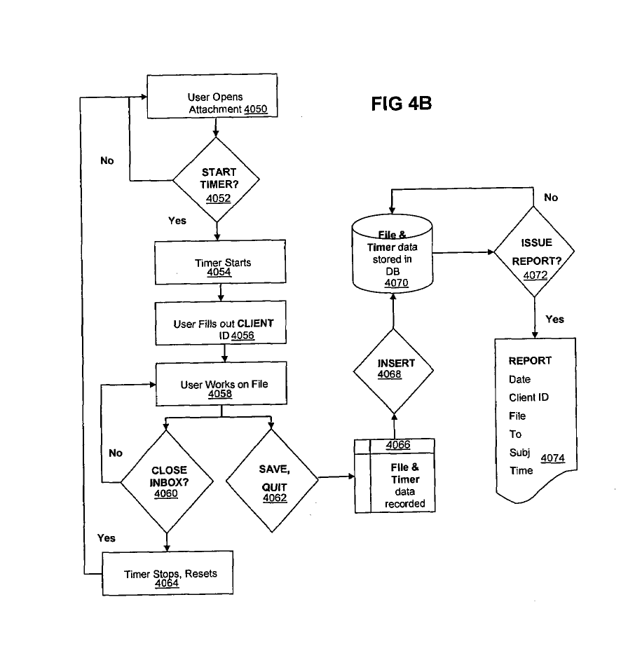

FIG. 4A illustrates an example procedure for a billing module to automatically capture billable time spent on viewing and composing emails. For example, the procedure can execute on a billing module installed on a workstation and monitor user interactions with an email client. In one embodiment, the billing module can be installed as a plug-in in the email client. In another embodiment, the billing module can execute as a daemon in an operating system background.

In 4000, the user opens a mailbox in an email client. For example, the email client can be Microsoft Outlook and the mailbox can be an Inbox of Microsoft Outlook.

In 4002, the user opens or views a selected email. For example, the user can double-click or otherwise select an email within the mailbox. The billing module detects the user action and proceeds to 4004.

In 4004, the billing module automatically starts a timer to track time spent on the selected email. For example, the user can spend time reading an email or composing a response to the email, all of which will be captured by the billing module.

In 4006, the billing module detects whether the user has closed or otherwise quit the selected email. If yes, the billing module proceeds to 4008.

In 4008, the billing module stops the timer started in 4004 associated with the selected email. The elapsed time recorded by the timer reflects the amount of time spent by the user in reading the email. The billing module then proceeds to 4004.

In an alternative embodiment, the billing module proceeds to 4002 and continues to wait for further user email interactions.

In an alternative embodiment, the billing module proceeds to 4022 to store billing information.

In one example embodiment, the billing module stores the elapsed time for later processing. For example, the user can read an email, but not initiate any action related to the email (such as drafting a reply or composing a new message). The billing module can prompt the user to ask for a reminder to take action at a later time, for example, by the end of the day.

In this example embodiment, the user can read an email, decide it can best be handled at a later time, indicate to the billing module that a reminder should be set, and later be automatically reminded of the email. The user can then take appropriate action on the email at the reminder time, for example, drafting a response email.

In 4010, the billing module detects whether the user has replied, replied all, or forwarded the selected email.

In 4012, the billing module detects whether the user has started composing a new email or a reply.

In 4014, the billing module inserts a client identifier to the email. This allows the email to be later identified with a billing information, billing record, or time slip.

In an alternative embodiment, the billing module can insert a globally-unique email identifier. In an alternative embodiment, the billing module can insert a billing identifier, as discussed above.

In 4016, the user completes composing the email.

In 4018, the user saves the email draft or sends the completed email.

In 4020, the billing module stops the timer started in 4004. An elapsed time recorded by the timer reflects the amount of time spent by the user in composing the email or email draft.

In 4022, a message and timer data is recorded by the billing module. A message identifier, a copy of the email, the elapsed time, a start and stop time, and any other relevant information is stored in accessible memory.

In 4024, the billing module inserts the information of 4022 into a message and sends the message to a workstation. For example, the billing module can execute on a mobile device, and this will allow the workstation to collect all billing information in a centralized format.

In 4026, the information of 4022 is stored in a database. For example, the information can be stored in a billing application or exported in a predefined format for later processing.

In 4028, the billing module tests whether the user requests a report on billable time. If yes, the billing module proceeds to 4030.

In 4030, the billing module generates the requested report. For example, the report can include an entry for each time slip stored in memory. Each entry includes a date, a client identifier, a “to” field, a “from” field, a date and time, and a number of emails sent.

The procedure then ends or returns to 4002.

FIG. 4B illustrates an example procedure for a billing module to automatically capture billable time spent viewing and editing email attachments. For example, the procedure can execute on a billing module installed on a workstation and monitor user interactions with an email client. In one embodiment, the billing module can be installed as a plug-in in the email client. In another embodiment, the billing module can execute as a daemon in an operating system background.

In 4050, the billing module detects the user opening an attachment within an email. For example, the attachment can be attached to an incoming email selected by the user. Attachments can be documents, spreadsheets, presentations, or any other file type usable by the user. In an alternative embodiment, the billing module detects the user clicking on a URL link to a website. In this embodiment, time spent by the user on the website can be processed as billable time.

In 4052, the billing module tests whether the timer should be started. If the timer is to be started, the billing module proceeds to 4054. If the timer is not to be started, the billing module returns to 4050.

In 4054, the billing module automatically starts a timer to track time spent on the opened attachment. For example, each opened attachment can be associated with a timer. Alternatively, each selected email can be associated with a timer that tracks all time spent on the email and any attachments.

In 4056, the user is prompted for a client identifier. A prompt is displayed and the user inputs a client identifier. In an alternative embodiment, the user can be prompted for a billing identifier. In an alternative embodiment, the billing identifier can be automatically detected from the selected email, the attachment, or a context.

In 4058, the user views or modifies the opened attachment. The attachment is opened in a corresponding application that allows the user to view or modify the attachment.

In 4060, the billing module tests whether the user has closed an inbox. If yes, the billing module proceeds to 4064. If no, the billing module remains at 4058.

In 4062, the billing module tests whether the user has saved the attachment or quit viewing or modifying the attachment. If yes, the billing module can stop the timer and proceed to 4066.

In 4064, the billing module stops the timer. The timer provides information such as an elapsed time, a start time, an end time, and any other relevant time information.

In 4066, the billing module stores a file and timer data. For example, the file can be the attachment, a snapshot of the attachment, or a description of what was viewed or modified in the attachment. The timer data can be retrieved from the timer started in 4052.

In 4068, the billing module inserts an identifier into the attachment. For example, the identifier can be a client identifier, a client/matter identifier, a billing identifier, or any other identifier to be associated with the timer data of 4066.

In 4070, the billing module stores the file and timer data into an accessible memory for later access.

In 4072, the billing module tests whether a user has requested a report. If yes, the billing module proceeds to 4074.

In 4074, the billing module generates the requested report. For example, the report can include an entry for each time slip stored in memory. Each entry includes a date, a client identifier, a file that was viewed or modified, a “to” field, a “subject” field, and a date and time.

The procedure then ends or returns to 4050.

As discussed above, one example embodiment of the present invention can be a method for automatically aggregating billable time for a plurality of billable events. The method comprises, responsive to detecting a billable event, determining a billing identifier associated with the billable event. The method comprises calculating a billable time amount associated with the billable event, the billable time amount selected from at least one of: an amount of time spent during the billable event and a user-inputted value. The method comprises storing the billing identifier and the billable time amount in an accessible storage. The method comprises, responsive to a predefined trigger, aggregating a plurality of billable time amounts associated with a selected billing identifier. The billable event can occur on a mobile computing device. The billable event can be at least one of: reading an email and composing an email. The billing identifier can be determined by examining at least one of: an email addressee and an email addressee domain name. The billable time amount can be rounded to a nearest user-set billable time increment. The predefined trigger can be at least one of: a predetermined periodic aggregation time and a user command. Only billable time amounts less than a user-set aggregation threshold can be aggregated. The billing identifier can be determined in accordance with a set of user-defined rules. The method comprises uploading the aggregated billable time amount and the billing identifier to a billing server.

Another embodiment of the present invention can be a system for automatically aggregating billable time for a plurality of billable events. The system comprises a workstation executing a software module. The module can be configured to, responsive to detecting a billable event, determine a billing identifier associated with the billable event. The module can be configured to calculate a billable time amount associated with the billable event, the billable time amount selected from at least one of: an amount of time spent during the billable event and a user-inputted value. The module can be configured to store the billing identifier and the billable time amount in an accessible storage. The module can be configured to, responsive to a predefined trigger, aggregate a plurality of billable time amounts associated with a selected billing identifier. The billable event can occur on a mobile computing device. The billable event can be at least one of: reading an email and composing an email. The billing identifier can be determined by examining at least one of: an email addressee and an email addressee domain name. The billable time amount can be rounded to a nearest user-set billable time increment. The predefined trigger can be at least one of: a predetermined periodic aggregation time and a user command.

Another embodiment of the present invention can be a computer-readable medium including instructions adapted to execute a method for automatically aggregating billable time for a plurality of billable events. The method comprises, responsive to detecting a billable event, determining a billing identifier associated with the billable event. The method comprises calculating a billable time amount associated with the billable event, the billable time amount selected from at least one of: an amount of time spent during the billable event and a user-inputted value. The method comprises storing the billing identifier and the billable time amount in an accessible storage. The method comprises, responsive to a predefined trigger, aggregating a plurality of billable time amounts associated with a selected billing identifier. The billable event can occur on a mobile computing device. The billable event can be at least one of: reading an email and composing an email. The billing identifier can be determined by examining at least one of: an email addressee and an email addressee domain name. The billable time amount can be rounded to a nearest user-set billable time increment. The predefined trigger can be at least one of: a predetermined periodic aggregation time and a user command. Only billable time amounts less than a user-set aggregation threshold can be aggregated. The billing identifier can be determined in accordance with a set of user-defined rules. The method comprises uploading the aggregated billable time amount and the billing identifier to a billing server.

Another embodiment of the present invention can be a method of billing time. The method comprises detecting a billable event, wherein the billable event is at least one of: reading an email, composing an email, expiration of an appointment event, completion of a task event, completion of a voice-over-IP telephone call, completion of a web-browsing event, completion of a webinar event, completion of an on-line document preparation, review or revision collaboration, and completion of drafting, reviewing or revising a document in a productivity application. The method comprises determining a billing identifier associated with the billable event. The method comprises calculating a billable time amount associated with the billable event. The method comprises storing the billing identifier and the billable time amount in an accessible storage. The method comprises determining a description of the billable event. The method comprises storing the description with the billing identifier and the billable time amount. The method comprises uploading the billing identifier and the billable time amount to a billing server. The billing identifier and the billable time amount can be uploaded in Extended Markup Language (XML) format. The billable time amount can be selected from one of: an amount of time spent during the billable event and a user-inputted value. The billing identifier can be determined from parsing metadata associated with the billable event. The predefined trigger can be at least one of: a predetermined periodic upload window and a user command. The billable time amount can be rounded to a nearest user-set billable time increment. The billing identifier can be determined in accordance with a set of user-defined rules.

Another embodiment of the present invention can be a system for billing time. The system comprises a workstation executing a software module. The module can be configured to detect a billable event, wherein the billable event is at least one of: reading an email, composing an email, expiration of an appointment event, completion of a task event, completion of a voice-over-IP telephone call, completion of a web-browsing event, completion of a webinar event, completion of an on-line document preparation, review or revision collaboration, and completion of drafting, reviewing or revising a document in a productivity application. The module can be configured to determine a billing identifier associated with the billable event. The module can be configured to calculate a billable time amount associated with the billable event. The module can be configured to store the billing identifier and the billable time amount in an accessible storage. The module can be configured to determine a description of the billable event. The module can be configured to store the description with the billing identifier and the billable time amount. The module can be configured to upload the billing identifier and the billable time amount to a billing server. The billing identifier and the billable time amount can be uploaded in Extended Markup Language (XML) format. The billable time amount can be selected from one of: an amount of time spent during the billable event and a user-inputted value. The billing identifier can be determined from parsing metadata associated with the billable event.

Another embodiment of the present invention can be a computer-readable medium including instructions adapted to execute a method for billing time. The method comprises detecting a billable event, wherein the billable event is at least one of: reading an email, composing an email, expiration of an appointment event, completion of a task event, completion of a voice-over-IP telephone call, completion of a web-browsing event, completion of a webinar event, completion of an on-line document preparation, review or revision collaboration, and completion of drafting, reviewing or revising a document in a productivity application. The method comprises determining a billing identifier associated with the billable event. The method comprises calculating a billable time amount associated with the billable event. The method comprises storing the billing identifier and the billable time amount in an accessible storage. The method comprises determining a description of the billable event. The method comprises storing the description with the billing identifier and the billable time amount. The method comprises uploading the billing identifier and the billable time amount to a billing server. The billing identifier and the billable time amount can be uploaded in Extended Markup Language (XML) format. The billable time amount can be selected from one of: an amount of time spent during the billable event and a user-inputted value. The billing identifier can be determined from parsing metadata associated with the billable event. The predefined trigger can be at least one of: a predetermined periodic upload window and a user command. The billable time amount can be rounded to a nearest user-set billable time increment. The billing identifier can be determined in accordance with a set of user-defined rules.

Another embodiment of the present invention can be a method of billing time. The method comprises, responsive to detecting a billable event, determining a billing identifier associated with the billable event. The method comprises calculating a billable time amount associated with the billable event. The method comprises determining a description associated with the billable event, wherein the description is determined from at least one of: an email subject, an email body, a calendar event description, a task event description; a voice-over-IP telephone event, a web-browsing event, a webinar event, an on-line document preparation, review or revision collaboration event, and a drafting, reviewing or revising of a document in a productivity application. The method comprises storing the billing identifier, the billable time amount, and the description in an accessible storage. The billable event can occur on a mobile computing device. The billable time amount can be rounded to a nearest user-set billable time increment. The billing identifier can be determined in accordance with a set of user-defined rules. The billing identifier can be received from a user or determined from parsing metadata associated with the billable event. The description, the billing identifier, and the billable time amount can be uploaded to a billing server in Extended Markup Language (XML) format. The billable time amount can be calculated from one of: an amount of time spent during the billable event and a user-inputted value.

Another embodiment of the present invention can be a system for billing time. The system comprises a workstation executing a software module. The module can be configured to, responsive to detecting a billable event, determine a billing identifier associated with the billable event. The module can be configured to calculate a billable time amount associated with the billable event. The module can be configured to determine a description associated with the billable event, wherein the description is determined from at least one of: an email subject, an email body, a calendar event description, a task event description, a voice-over-IP telephone event description, a web-browsing event description, a webinar event description, an on-line document preparation, review or revision collaboration event description, and a drafting, reviewing or revising of a document in a productivity application description. The module can be configured to store the billing identifier, the billable time amount, and the description in an accessible storage. The billable event can occur on a mobile computing device. The billable time amount can be rounded to a nearest user-set billable time increment. The billing identifier can be determined in accordance with a set of user-defined rules. The billing identifier can be received from a user or determined from parsing metadata associated with the billable event. The description, the billing identifier, and the billable time amount can be uploaded to a billing server in Extended Markup Language (XML) format. The billable time amount can be calculated from one of: an amount of time spent during the billable event and a user-inputted value.

Another embodiment of the present invention can be a computer-readable medium including instructions adapted to execute a method for billing time. The method comprises, responsive to detecting a billable event, determining a billing identifier associated with the billable event. The method comprises calculating a billable time amount associated with the billable event. The method comprises determining a description associated with the billable event, wherein the description is determined from at least one of: an email subject, an email body, a calendar event description, a task event description; a voice-over-IP telephone event, a web-browsing event, a webinar event, an on-line document preparation, review or revision collaboration event, and a drafting, reviewing or revising of a document in a productivity application. The method comprises storing the billing identifier, the billable time amount, and the description in an accessible storage. The billable event can occur on a mobile computing device. The billable time amount can be rounded to a nearest user-set billable time increment. The billing identifier can be determined in accordance with a set of user-defined rules. The billing identifier can be received from a user or determined from parsing metadata associated with the billable event. The description, the billing identifier, and the billable time amount can be uploaded to a billing server in Extended Markup Language (XML) format. The billable time amount can be calculated from one of: an amount of time spent during the billable event and a user-inputted value.

Another embodiment of the present invention can be a method of billing time. The method comprises loading a daemon into memory and executing the daemon to provide a billing module. The method comprises detecting a billable event with the daemon, wherein the billable event is at least one of: reading an email, composing an email, expiration of an appointment event, completion of a task event, completion of a voice-over-IP telephone call, completion of a web-browsing event, completion of a webinar event, completion of an on-line document preparation, review or revision collaboration, and completion of drafting, reviewing or revising a document in a productivity application. The method comprises determining a billing identifier associated with the billable event. The method comprises calculating a billable time amount associated with the billable event. The method comprises storing the billing identifier and the billable time amount in an accessible storage. The method comprises determining a description of the billable event. The method comprises storing the description with the billing identifier and the billable time amount. The method comprises uploading the billing identifier and the billable time amount to a billing server. The billing identifier and the billable time amount can be uploaded in Extended Markup Language (XML) format. The billable time amount can be selected from one of: an amount of time spent during the billable event and a user-inputted value. The billing identifier can be determined from parsing metadata associated with the billable event. The predefined trigger can be at least one of: a predetermined periodic upload window and a user command. The billable time amount can be rounded to a nearest user-set billable time increment. The billing identifier can be determined in accordance with a set of user-defined rules.

Another embodiment of the present invention can be a system for billing time. The system comprises a workstation executing a software module, wherein the software module is loaded into a memory and executed as a daemon. The module can be configured to detect a billable event, wherein the billable event is at least one of: reading an email, composing an email, expiration of an appointment event, completion of a task event, completion of a voice-over-IP telephone call, completion of a web-browsing event, completion of a webinar event, completion of an on-line document preparation, review or revision collaboration, and completion of drafting, reviewing or revising a document in a productivity application. The module can be configured to determine a billing identifier associated with the billable event. The module can be configured to calculate a billable time amount associated with the billable event. The module can be configured to store the billing identifier and the billable time amount in an accessible storage. The module can be configured to determine a description of the billable event. The module can be configured to store the description with the billing identifier and the billable time amount. The module can be configured to upload the billing identifier and the billable time amount to a billing server. The billing identifier and the billable time amount can be uploaded in Extended Markup Language (XML) format. The billable time amount can be selected from one of: an amount of time spent during the billable event and a user-inputted value. The billing identifier can be determined from parsing metadata associated with the billable event.

Another embodiment of the present invention can be a computer-readable medium including instructions adapted to execute a method for billing time. The method comprises loading a daemon into memory and executing the daemon to provide a billing module. The method comprises detecting a billable event with the daemon, wherein the billable event is at least one of: reading an email, composing an email, expiration of an appointment event, completion of a task event, completion of a voice-over-IP telephone call, completion of a web-browsing event, completion of a webinar event, completion of an on-line document preparation, review or revision collaboration, and completion of drafting, reviewing or revising a document in a productivity application. The method comprises determining a billing identifier associated with the billable event. The method comprises calculating a billable time amount associated with the billable event. The method comprises storing the billing identifier and the billable time amount in an accessible storage. The method comprises determining a description of the billable event. The method comprises storing the description with the billing identifier and the billable time amount. The method comprises uploading the billing identifier and the billable time amount to a billing server. The billing identifier and the billable time amount can be uploaded in Extended Markup Language (XML) format. The billable time amount can be selected from one of: an amount of time spent during the billable event and a user-inputted value. The billing identifier can be determined from parsing metadata associated with the billable event. The predefined trigger can be at least one of: a predetermined periodic upload window and a user command. The billable time amount can be rounded to a nearest user-set billable time increment. The billing identifier can be determined in accordance with a set of user-defined rules.

Although the above embodiments have been discussed with reference to specific example embodiments, it will be evident that the various modification, combinations and changes can be made to these embodiments. Accordingly, the specification and drawings are to be regarded in an illustrative sense rather than in a restrictive sense. The foregoing specification provides a description with reference to specific exemplary embodiments. It will be evident that various modifications may be made thereto without departing from the broader spirit and scope as set forth in the following claims. The specification and drawings are, accordingly, to be regarded in an illustrative sense rather than a restrictive sense.

What is claimed is:

1. A method for automatically aggregating billable time for a plurality of billable events, comprising:
responsive to detecting a billable event, determining a billing identifier associated with the billable event;
calculating a billable time amount associated with the billable event, the billable time amount selected from at least one of: an amount of time spent during the billable event and a user-inputted value;
storing the billing identifier and the billable time amount in an accessible storage; and
responsive to a predefined trigger, aggregating a plurality of billable time amounts associated with a selected billing identifier.

2. The method of claim 1, wherein the billable event occurs on a mobile computing device.

3. The method of claim 1, wherein the billable event is at least one of: reading an email and composing an email.

4. The method of claim 3, wherein the billing identifier is determined by examining at least one of: an email addressee and an email addressee domain name.

5. The method of claim 1, wherein the billable time amount is rounded to a nearest user-set billable time increment.

6. The method of claim 1, wherein the predefined trigger is at least one of: a predetermined periodic aggregation time and a user command.

7. The method of claim 1, wherein only billable time amounts less than a user-set aggregation threshold are aggregated.

8. The method of claim 1, wherein the billing identifier is determined in accordance with a set of user-defined rules.

9. The method of claim 1, further comprising:
uploading the aggregated billable time amount and the billing identifier to a billing server.

10. A system for automatically aggregating billable time for a plurality of billable events, the system comprising:
a workstation executing a software module, the module configured to,
responsive to detecting a billable event, determine a billing identifier associated with the billable event,
calculate a billable time amount associated with the billable event, the billable time amount selected from at least one of: an amount of time spent during the billable event and a user-inputted value,
store the billing identifier and the billable time amount in an accessible storage, and
responsive to a predefined trigger, aggregate a plurality of billable time amounts associated with a selected billing identifier.

11. The system of claim 10, wherein the billable event occurs on a mobile computing device.

12. The system of claim 10, wherein the billable event is at least one of: reading an email and composing an email.

13. The system of claim 12, wherein the billing identifier is determined by examining at least one of: an email addressee and an email addressee domain name.

14. The system of claim 10, wherein the billable time amount is rounded to a nearest user-set billable time increment.

15. The system of claim 10, wherein the predefined trigger is at least one of: a predetermined periodic aggregation time and a user command.

16. A computer-readable medium including instructions adapted to execute a method for automatically aggregating billable time for a plurality of billable events, the method comprising:
responsive to detecting a billable event, determining a billing identifier associated with the billable event;
calculating a billable time amount associated with the billable event, the billable time amount selected from at least one of: an amount of time spent during the billable event and a user-inputted value;
storing the billing identifier and the billable time amount in an accessible storage; and
responsive to a predefined trigger, aggregating a plurality of billable time amounts associated with a selected billing identifier.

17. The medium of claim 16, wherein only billable time amounts less than a user-set aggregation threshold are aggregated.

18. The medium of claim 16, wherein the billing identifier is determined in accordance with a set of user-defined rules.

19. The medium of claim 16, further comprising:
uploading the aggregated billable time amount and the billing identifier to a billing server.

20. The medium of claim 16, wherein the billable event occurs on a mobile computing device.

21. A method of billing time, comprising:
detecting a billable event, wherein the billable event is at least one of: reading an email, composing an email, expiration of an appointment event, completion of a task event, completion of a voice-over-IP telephone call, completion of a web-browsing event, completion of a webinar event, completion of an on-line document preparation, review or revision collaboration, and completion of drafting, reviewing or revising a document in a productivity application;
determining a billing identifier associated with the billable event;
calculating a billable time amount associated with the billable event; and
storing the billing identifier and the billable time amount in an accessible storage.

22. The method of claim 1, further comprising:
determining a description of the billable event; and
storing the description with the billing identifier and the billable time amount.

23. The method of claim 1, further comprising:
uploading the billing identifier and the billable time amount to a billing server.

24. The method of claim 3, wherein the billing identifier and the billable time amount are uploaded in Extended Markup Language (XML) format.

25. The method of claim 1, wherein the billable time amount selected from one of: an amount of time spent during the billable event and a user-inputted value.

26. The method of claim 1, wherein the billing identifier is determined from parsing metadata associated with the billable event.

27. The method of claim 1, wherein the predefined trigger is at least one of: a predetermined periodic upload window and a user command.

28. The method of claim 1, wherein the billable time amount is rounded to a nearest user-set billable time increment.

29. The method of claim 1, wherein the billing identifier is determined in accordance with a set of user-defined rules.

30. A system for billing time, the system comprising:
a workstation executing a software module, the module configured to,
detect a billable event, wherein the billable event is at least one of: reading an email, composing an email, expiration of an appointment event, completion of a task event, completion of a voice-over-IP telephone call, completion of a web-browsing event, completion of a webinar event, completion of an on-line document preparation, review or revision collaboration, and completion of drafting, reviewing or revising a document in a productivity application;
determine a billing identifier associated with the billable event,
calculate a billable time amount associated with the billable event, and
store the billing identifier and the billable time amount in an accessible storage. storage.

31. The system of claim 10, the module further configured to,
determine a description of the billable event, and
store the description with the billing identifier and the billable time amount.

32. The system of claim 10, the module further configured to
upload the billing identifier and the billable time amount to a billing server.

33. The system of claim 12, wherein the billing identifier and the billable time amount are uploaded in Extended Markup Language (XML) format.

34. The system of claim 10, wherein the billable time amount selected from one of: an amount of time spent during the billable event and a user-inputted value.

35. The system of claim 10, wherein the billing identifier is determined from parsing metadata associated with the billable event.

36. A computer-readable medium including instructions adapted to execute a method for billing time, the method comprising:
detecting a billable event, wherein the billable event is at least one of: reading an email, composing an email, expiration of an appointment event, completion of a task event, completion of a voice-over-IP telephone call, completion of a web-browsing event, completion of a webinar event, completion of an on-line document preparation, review or revision collaboration, and completion of drafting, reviewing or revising a document in a productivity application;
determine a billing identifier associated with the billable event;
calculating a billable time amount associated with the billable event; and
storing the billing identifier and the billable time amount in an accessible storage.

37. The medium of 16, wherein the predefined trigger is at least one of: a predetermined periodic upload window and a user command.

38. The medium of 16, wherein the billable time amount is rounded to a nearest user-set billable time increment.

39. The medium of 16, wherein the billing identifier is determined in accordance with a set of user-defined rules.

40. The medium of 16, wherein the method further includes
determining a description of the billable event, and
storing the description with the billing identifier and the billable time amount.
